(19) United States
(12) Patent Application Publication
(10) Pub. No.: US 2014/0290558 A1
(43) Pub. Date: Oct. 2, 2014

(54) Thaw Alert

(71) Applicant: Kevin Barry Sheehy, SR., Chicago, IL (US)

(72) Inventor: Kevin Barry Sheehy, SR., Chicago, IL (US)

(21) Appl. No.: 13/986,111

(22) Filed: Apr. 2, 2013

(51) Int. Cl. G01K 1/02

(52) U.S. Cl. CPC G01K 1/02
USPC 116/201; 116/216

(57) ABSTRACT

The thaw indicator is a device to determine if a frozen space has gone thru an undesired temperature change and if so remains in an alert position until manually reset even if the temperature corrects itself. It's made up of three major components a base, a piston indicator and a transparent tube. When frozen the thaw indicator looks like a thermometer when unfrozen it looks like a thermometer that has jumped out of its case indicating a change of temperature and state with great certainty. It has been designed to stay out of the way but in plain sight.

### CROSS-REFERENCE TO RELATED APPLICATIONS

This application claims the benefit of provisional patent application Ser. No. 61/6,190,004 Filed 2012 Apr. 2

### FEDERALLY SPONSORED RESEARCH

Not Applicable

### SEQUENCE LISTING OR PROGRAM

Not Applicable

### BACKGROUND

1. Field

This application relates to an indication apparatus and more particularly to a device for indicating not only a change in temperature but also a change in state.

2. Prior Art

In the preparation of food stuffs, both raw and cooked, it is desirable to have some manner of indicating whether frozen items have previously been thawed. This is true in both home and commercial (such as grocery store, Supermarket, or Restaurant) settings. Such information is useful from health, safety and nutritional stand points.

Accordingly there is a need for a low-cost thaw indicator which can be associated with a thaw sensitive host product for example by attaching the thaw indicator to the appliance and the appliance apparatus that store such items.

A number of proposals for such thaw indicators are known. For example, U.S. Pat. No. 4,292,714 to Cooperman; Salkind (1977) that actually attaches to the frozen product. U.S. Pat. No. 4,114,443 to Clark (1978) shows a container freeze thaw indicator that is set on its side in freezer compartment. This makes access to freezer cumbersome and indicator can get pushed around and does not stay in one spot. U.S. Pat. No. 4,064,828 to Clark (1977) this device unlike Clarks other thaw indicator that lies on its side, free stands in the upright position. This can be knocked over and prevent access to items or have to move around to different temporary locations when stocking or unloading frozen space. U.S. Pat. No. 4,022,149 to Berger (1977) this device is made of deformation of cast geo metric shapes of ice. This kind of invention is irreversible and can only have one time use. All of these devices appear to be unable to perform their intended purpose of displaying indication status if knocked over. All of these products are all susceptible to resembling the Activity-directed stacking piece game “JENGA” U.S. Pat. No. 6,679,496. Frozen spaces in appliances always seem to have voided space between apparatuses shelving and compartments once initially stocked. Consumers feel the need to fill those voids with product, causing unstable stacking space. None of the above references seem to be able to overcome the disadvantages of this real fact. In addition to the already listed disadvantages they present.

### SUMMARY OF INVENTION

The present invention provides a thaw indicator which can be re-used after thawing. The thaw indicator of the present invention has multiple hanging devices to accommodate different appliances and remain stable and operable in congested conditions.

The thaw indicator is comprised of a base with hooks and a clip having a central opening, suspending on its underside a hollow transparent tube closed on distal end. That when aligned can receive water and piston, buoy, indicator thru openings. When offset the indicator can be put in tube and remain submerged, then placed in a frozen space. Once frozen the two pieces can be aligned and re hung in freezer. If temperature goes above an undesired set point the piston will be released and float up to indicate items in frozen space had a change in state.

A detailed description following, relates to the drawings, gives exemplification of apparatus according to the invention which, however, is capable or expression in means other than those particularly described and illustrated.

DRAWINGS-Figures

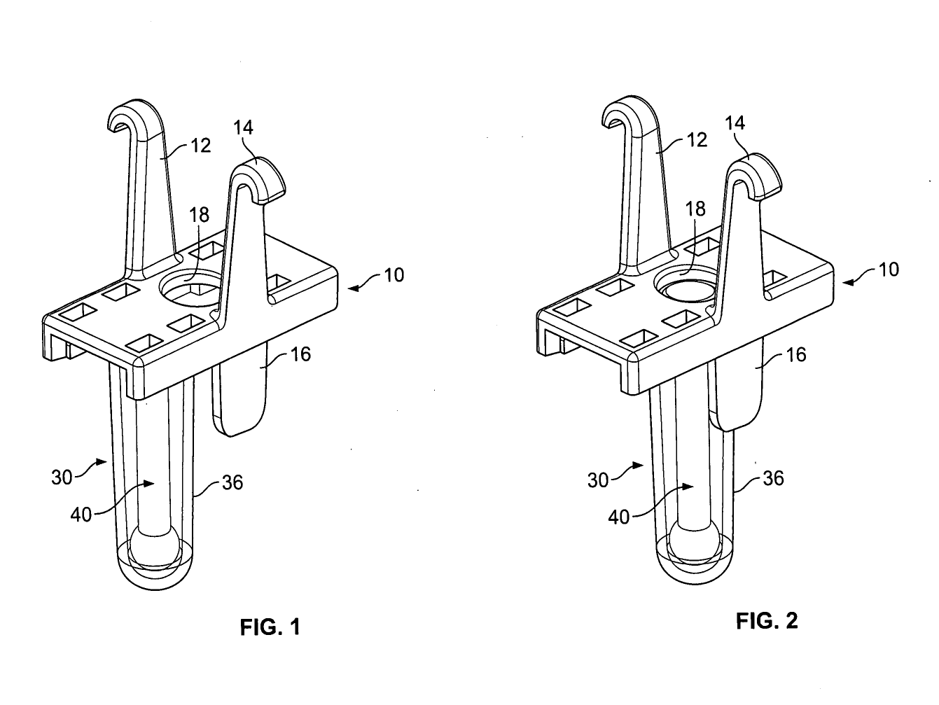

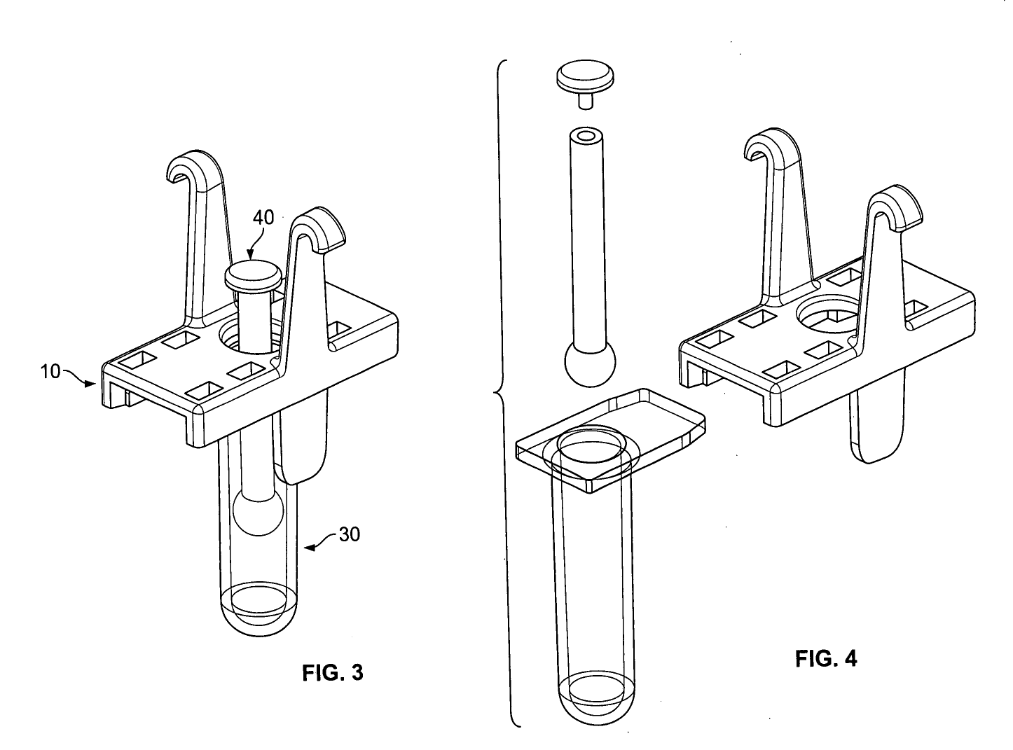

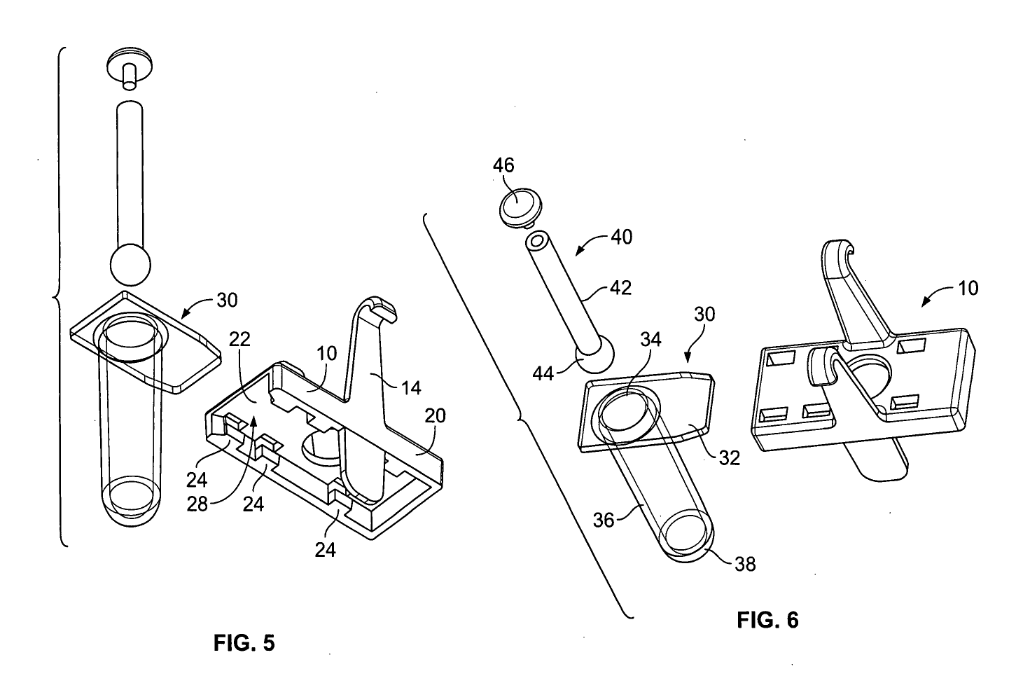

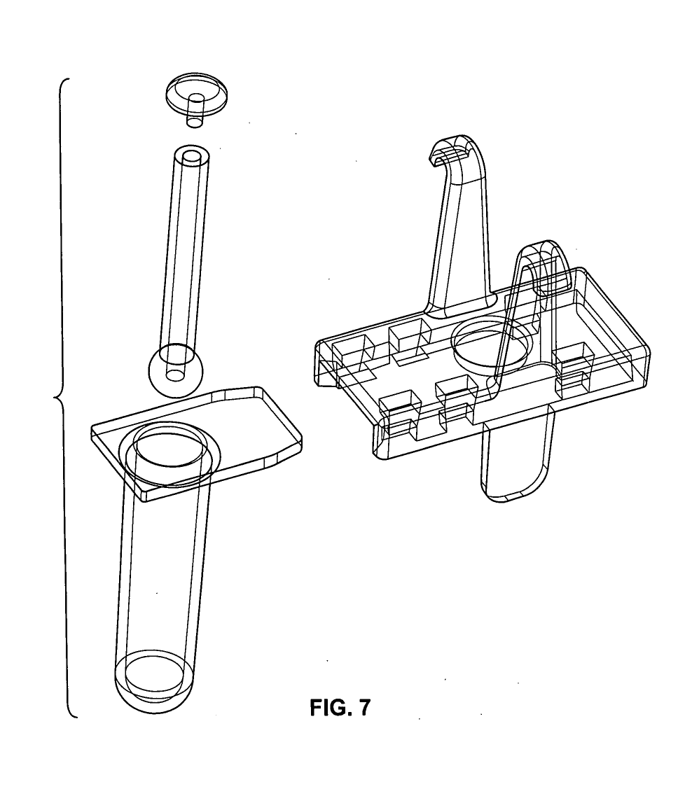

FIG. 1 is an overall view with piston and tube to the side.
FIG. 2 is an overall view with piston and tube in the center.
FIG. 3 is an assembled view piston up.
FIG. 4 is an exploded view.
FIG. 5 is an exploded view from below.
FIG. 6 is an exploded view from above.
FIG. 7 is a transparent view

DRAWING-Reference Numerals

10 base
12 14 hooks
16 downwardly extending tab
18 central opening
20 perimeter wall
22 open entry end
24 inwardly extending tab
28 a channel
30 holder
32 plate
34 through opening
36 tube
38 closed tube end (distal)
40 piston
42 elongated tube
44 spherical closed end
46 cap

### DETAILED DESCRIPTION

### FIG. 1-FIG. 7

This invention relates to a thaw alert device used to indicate if a frozen space has undergone an undesired thawing condition. FIG. 1-7 illustrate a thaw alert device of present embodiment.

Referring to FIGS. 1-7 the thaw alert device comprises a base 10 having opposite hooks 12 and 14 extending upwardly there from. A tab 16 extending downwardly from the base 10 below the second hook 14. The base 10 includes a central opening 18. The base 10 includes a perimeter wall 20 extending around three sides and open at an entry end 22. Pluralities of tabs 24 each extend inwardly from the perimeter wall 20 to define a channel 28.

A holder 30 see FIG. 6, comprises a plate 32 of a size to be received in the channel 28. A through opening 34 is aligned with a hollow tube 36 extending downwardly from plate 32. The tube 36 is closed at a distal end 38.

A piston 40 comprises an elongated tube 42 having a spherical closed end 44 and closed at top with cap 46. The size of the cap is of similar size to the inner diameter of the tube 36 and the base central opening 18.

This device would be made of an injection molded thermoplastic material. The base 10 would be made of a flexible material that could be inferior to the tube 36 that must be stronger due to the nature of expansion of liquid it would contain, possibly a polypropylene. The piston must have a density lighter than water and could possibly be made of a polyethylene material. Substitutions for that material or interchanges between materials must take into consideration the stresses and attention to specific gravity, mentioned above.

### Operation—FIGS. 1-7

In use, the tube 36 is filled with water. The piston 40 is placed in the tube 36. The holder 30 is positioned in the channel 28 in the position shown in FIG. 1 The device is then placed in a frozen space with the hooks 12 and 14 used to suspend the device below, for example a shelf. Alternatively, the hook 14 and the tab 16 can be used to mount the device to a drawer or the like. Once the water in the tube 36 is frozen, the holder 30 is moved to the position shown in FIG. 2 with the tube 36 aligned with central opening 18. Because the water in the tube 36 is frozen, the piston 40 remains in the submerged position. If thawing occurs, then the piston 40 owing to its buoyancy, will raise up to the piston shown in FIG. 3. Even if the frozen space subsequently refreezes, the piston 40 will remain in the raised position to provide an indication that any contents of the frozen space may have thawed.

There are various possibilities with regard to additional embodiments. The base of FIG. 1-7 may or may not have both the hooks and tab. It may have one or the other. The tab could be a clip for example, spring loaded or not. There is yet another embodiment that allows for a hook and clip made of medal wire that is attached to the base and then used to attach to inside of frozen space. Also a similarly designed wire with an eye loop and hook that the tube slides down in, and then attached to inside of cold space.

With regard to the piston there are further embodiments comprising a cylinder closed at a bottom wall and having a pair of upwardly extending legs closed at a rim. In another embodiment of the piston, there are only the upwardly extending legs from the closed bottom wall.

Although the description above contain many specificities, these should not be construed as limiting the scope of the embodiments but as merely providing illustrations of some of the present and future, preferred embodiments.

I claim:

1. A thaw alert indicating device comprising:
(a) A base with a centrally located opening comprising a channel of two or more walls having means for hanging in suspension.
(b) A hollow tube closed on distal end with plate holder on proximal open end.
(c) A piston comprised of an elongated tube having a spherical closed and and closed at top with a cap.

2. The base of claim 1 (a) having opposite hooks extending upwardly there from.

3. The base of claim 1 (a) having a tab extending downwardly from said base.

4. The base of claim 3 having both opposite hooks extending upwardly there from and a tab extending downwardly from said base.

5. The base of claim 1 (a) having a central opening.

6. The base of claim 5 having a channel on underside with three perimeter walls.

7. The base of claim 6 having a plurality of tabs that extends inwardly from the perimeter walls of underside of said base.

8. The tube of claim 1 (b) comprised of a holder plate on proximal end.

9. The plate holder of claim 8 having a hollow tube extending downwardly from said plate with a closure on distal end.

10. The piston of claim 1 (c) having an elongated tube with spherical closed end capped at the top.

11. The cap of claim 10 being of similar size of hollow tube of claim 9.

12. The piston of claim 10 having a cavity in elongated tube.

13. A thaw indicator device that has a universal understanding of its operation by way of assembly, structure and components in regards to its base, tube and piston during desired and undesired space temperatures change.

14. The piston of claim 13 rises above base surface with rising temperature due to solid mass of said pistons distal end and lighter elongated cavity tube.

15. The piston of claim 14 is guided by cap similarly sized to tube of claim 13 and central opening of base of claim 13.

16. The base of claim 13 having hooks extending upwardly allowing unobstructed passage of piston of claim 13.

17. A method for a Thaw indicating device that uses apparatus of cold space to display said device unobstructed.
(a) A tube is filled with water and piston is placed inside.
(b) The holder of said tube is placed in the channel of a base until contact is made with back wall with piston submerged.
(c) The device is then placed in frozen space with hanger supports.
(d) Once the water in tube is frozen the tube will be slid over to align with opening of said base.
(e) The device is then returned to cold space by way of hanging with alignment of base and tube with frozen piston inside.
